(19) United States
(12) Patent Application Publication
(10) Pub. No.: US 2006/0082602 A1
(43) Pub. Date: Apr. 20, 2006

(54) Color display system

(75) Inventors: Yuh-Ren Shen, Taipei (TW); Han-Jon Ho, Kaohsiung (TW); Chang-Cheng Lin, Taipei (TW); Cheng-Jung Chen, Miaoli Hsien (TW)

Correspondence Address: DENNISON, SCHULTZ, DOUGHERTY;& MACDONALD, SUITE 105, 1727 KING STREET, ALEXANDRIA, VA, 22314-2700, US

(73) Assignee: VASTVIEW TECHNOLOGY INC.

(21) Appl. No.: 10/965,808

(22) Filed: Oct. 18, 2004

(51) Int. Cl. G09G 5/10

(52) U.S. Cl. 345/690

(57) ABSTRACT

A color display system comprises a color signal source, a buffer unit, a storage unit, an enlarging module, a comprising unit, and a multi-functional comparing unit. By the multi-functional comparing unit comparing an OD enlarged value of the enlarging module, a grayscale of the color signal source, and a signal for OD technique free of the comparing unit and then submitting a result, either the grayscale of the now-frame or the OD enlarged value, the color display system can fast and accurate response and display grayscales of colors. The color display system is applicable to use for LCD (liquid crystal display), PDP (Plasma Display Panel), TFT, OLED (Organic Electro Luminesence Display), and PLED (Polymer OLED).

### BACKGROUND OF THE INVENTION

1. Field of the invention

The present invention is related to a color display system, especially to a color display system that can compare the difference between grayscales of a pre-frame and a now-frame, and then determine to add or not an OD (Over Driving) enlarged value when displaying. The color display system therefore can faster and more accurate display, and is applicable for various color display devices.

2. Description of the Prior Art

Response time is an important index for judging the characteristics of a LCD panel. There are two modules of a LCD panel when without inputting voltage, Normally White, NW, and Normally Black, NB. The NW module means that a frame of a LCD panel without inputting voltage is pervious to light, while the NB module is pervious to dark. Giving an example of NW module, the response time can be divided into two parts:
(1) Rising response time (Tᵣ): time for twisting liquid crystal of a LCD cell gap from 90 percent to 10 percent luminance, even adding voltage
(2) Falling response time (T_{f}): time for twisting liquid crystal of a LCD cell gap from 10 percent to 90 percent luminance, even no adding voltage

Although displaying more than 25 frames per second will make people regarding these frames as a continuous frame, the demand of nowadays visual entertainments is much more than. For example, playing a DVD (Digital Video Display) player or a Playstation, the display demand of them usually are more than 60 frames per second. That is, each frame interval is only 16.67 ms.. If the response time of a LCD is more than that, the LCD will display incomplete images, and that will critical affect the quality of people's watching.

A good solution for reducing response time and accelerating response speed is to improve the factors of them. The following are the functions of rising response time (Tᵣ) and falling response time (T_{ƒ}):

$${T}_{r} = \frac{{r}_{1} {d}^{2}}{Δ ɛ ( {V}^{2} - {V}_{th}^{2} )} \qquad {T}_{f} = \frac{{r}_{1} {d}^{2}}{Δ ɛ {V}_{th}^{2}}$$

γ₁: rotational viscosity of liquid crystal material

d: cell gap

V: driving voltage

Δε: dielectric anisotropy

Hence, the good solution has four ways: smaller rotational viscosity, smaller cell gap, larger driving voltage, and larger dielectric anisotropy. The way of larger driving voltage is called Over Drive (OD) technique, which is giving a larger voltage to earlier twist and respond liquid crystal for satisfying the grayscale demand of image data.

The general grayscale of nowadays image standard is 8 bits and that means 255 grayscales for each of RGB colors, R for red, G for Green, and B for blue. To implement the mentioned OD technique, respective and appropriate OD voltages for changing color grayscales in different timings are needed. However, even only displaying a single color between two different timings that could have 65536 different demands for OD values.

When a LCD wants to satisfy the demands of the OD values for RGB colors, it must storage at least three times the number of the OD values mentioned above, and that is a huge pressure to memory demand, and also to the cost of a LCD. Reducing the number of the OD values and using them to simulate the real OD values and display then is the conventional solution.

The conventional ways of reducing the number of the OD values are calculating and simulating with some specific functions and OD assumed values, the functions can be polynomial, bilinear, or liner combination of orthogonal functions. Due to that, the simulation is very hard to accurate approach the real OD values, and critically affect the response time/response speed and the color display. In addition, when a LCD uses an OD value over its real demand, it cannot display color clearly.

In view of the above stated conventional defects, for providing a color display system which uses faster and more accuracy signal processing method for grayscale response speed of a panel by shrinking and enlarging OD values, the inventors provide the present invention according to academic research and designing as well as improvement in experiments.

### SUMMARY OF THE INVENTION

The primary object of the present invention is to provide a faster and more accurate responding and displaying color display system by using or not an OD value depends on the result of comparing the grayscales of the pre-frame and the now-frame.

In order to achieve the above subject, the present invention includes:

a color signal source for proving color signal,

a buffer unit for temporary saving a grayscale of a pre-frame of a color display system;

a storage unit for saving OD (Over Driving) shrink value tables P, Q, R, and S;

an enlarging module for enlarging OD values, including a collecting unit, a calculating unit, and a enlarging unit;

a comparing unit; and

a multi-functional comparing unit;

the color display system comprising the steps of:
(1) inputting a grayscale of a pre-frame from the buffer unit to the enlarging module, and inputting grayscale of a now-frame from the color signal source to the comparing unit, the now-frame is after the pre-frame;
(2) the collecting unit collecting some specific shrink OD values from the shrink OD value tables P, Q, R, and S by reference the grayscales of the pre-frame and the now-frame to build grayscale functions g₁(y), g₂(y) h₁(x), and h₂(x), calculating the grayscale functions by the calculating unit to develop grayscale functions g(y) and h(x), then the enlarging unit enlarging and getting an OD enlarged value with the function ƒ(x, y)=c×h(x)×g(y);
(3) the comparing unit comparing the grayscales of the pre-frame and the now-frame, if the grayscales being the same or nearly the same, the comparing unit submitting a signal for OD technique free; and
(4) the OD enlarged value, the grayscale of the now-frame, and the signal for OD technique free can being inputting into the multi-functional comparing unit, if the multi-functional comparing unit get the signal for OD technique free, it submitting the grayscale of the now-frame, if not, submitting the OD enlarged value;
   thereby, running the steps above for a color display system faster and more accurate displaying.

The present invention will be more apparent after reading the detailed description of the preferred embodiment thereof in reference to the accompanying drawings.

### BRIEF DESCRIPTION OF THE DRAWINGS

FIG. 1 is a system structure diagram of a first embodiment of the present invention;

FIG. 2 is a step diagram of a first embodiment of the present invention;

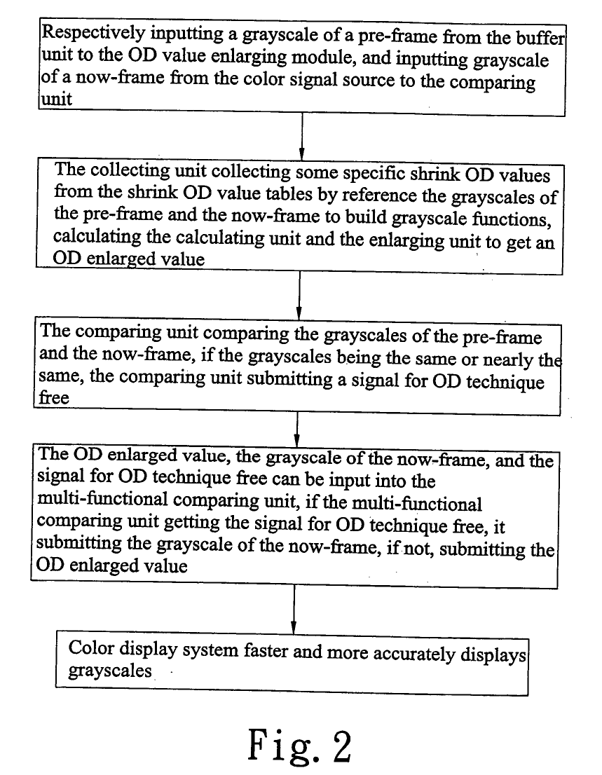

FIG. 3 is a system structure diagram a second embodiment of the present invention

FIG. 4 is the step diagram of a second embodiment of the present invention

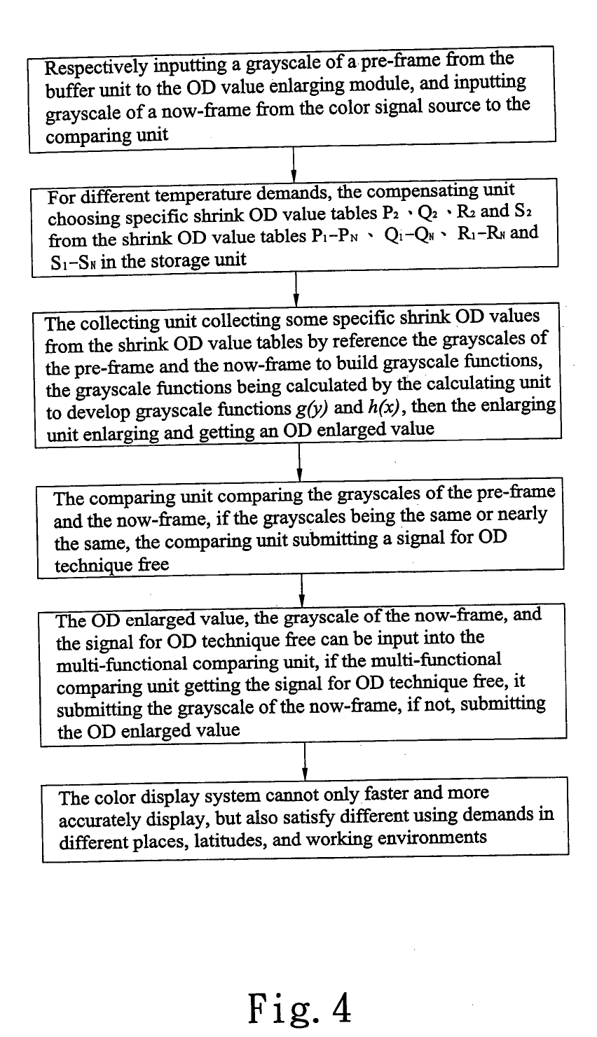

### DETAILED DESCRIPTION OF THE PREFERRED EMBODIMENT

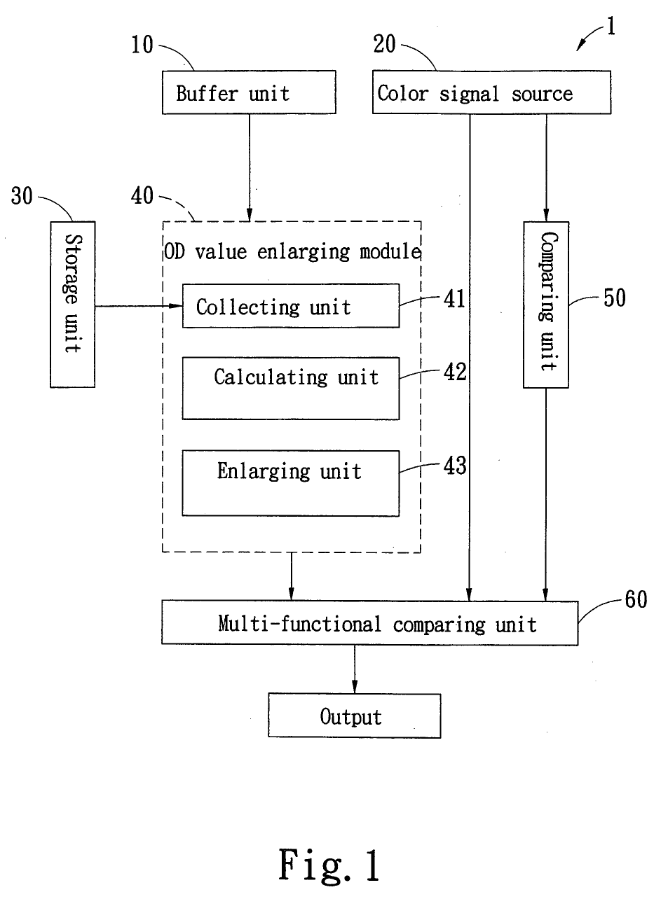

Referring to FIG. 1, the first embodiment of the color display system 1 of the present invention comprises: a buffer unit 10 for temporary saving a grayscale of a pre-frame of the color display system 1; a color signal source 20 for proving color signal; a storage unit 30 for saving OD (Over Driving) shrink value tables P, Q, R, and S; an enlarging module 40 for enlarging OD values, including a collecting unit 41, a calculating unit 42, and an enlarging unit 43; a comparing unit 50; and a multi-functional comparing unit 60.

The first embodiment of the color display system 1 of the present invention color display system comprising the steps of:
(1) inputting a grayscale of a pre-frame from the buffer unit 10 to the enlarging module 40, and inputting grayscale of a now-frame from the color signal source 20 to the comparing unit 50, the now-frame is after the pre-frame;
(2) the collecting unit 41 collecting some specific shrink OD values from the shrink OD value tables P, Q, R, and S 31, 32, 33, 34 by reference the grayscales of the pre-frame and the now-frame to build grayscale functions g₁(y), g₂(y) h₁(x), and h₂(x), calculating the grayscale functions by the calculating unit 42 to develop grayscale functions g(y) and h(x), then the enlarging unit 43 enlarging and getting a OD enlarged value with the function ƒ(x, y)=c×h(x)×g(y);
(3) the comparing unit 50 comparing the grayscales of the pre-frame and the now-frame, if the grayscales being the same or nearly the same, the comparing unit 50 submitting a signal for OD technique free;
(4) the OD enlarged value, the grayscale of the now-frame, and the signal for OD technique free can being inputting into the multi-functional comparing unit 60, if the multi-functional comparing unit 60 get the signal for OD technique free, it submitting the grayscale of the now-frame, if not, submitting the OD enlarged value;
   thereby, running the steps above for the color display system 1 faster and more accurate displaying.

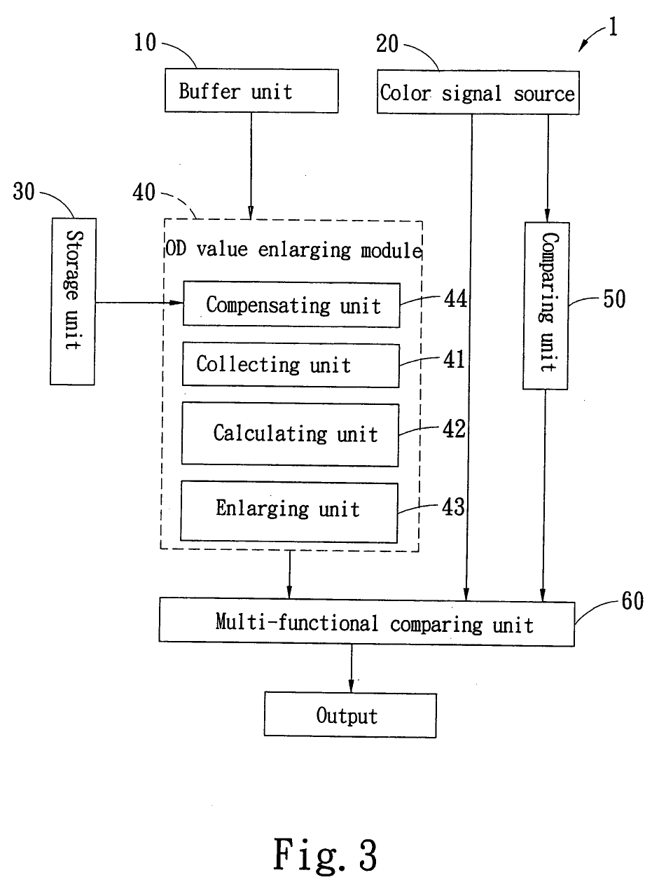

Referring to FIG. 3, besides the elements mentioned in the first embodiment, the second embodiment of the color display system 1 of the present invention further comprises that said enlarging module 40 further has a compensating unit 44 and the storage unit 30 further has shrink OD value tables P₁-P_{N}, [symbol] Q₁-Q_{N}, [symbol] R₁-R_{N} and S₁-S_{N}, which depends on temperature, N is the sum number of the tables.

The second embodiment of the color display system 1 of the present invention color display system comprising the steps of:
(1) inputting a grayscale of a pre-frame from the buffer unit 10 to the enlarging module 40, and inputting grayscale of a now-frame from the color signal source 20 to the comparing unit 50, the now-frame is after the pre-frame;
(2) for different temperature demands, the compensating unit 44 choosing specific shrink OD value tables P₂, [symbol] Q₂, [symbol] R₂ and S₂ from the shrink OD value tables P₁-P_{N}, [symbol] Q₁-Q_{N}, [symbol] R₁-R_{N} and S₁-S_{N} 31, 32, 33, 34 in the storage unit 30;
(3) the collecting unit 41 collecting some specific shrink OD values from the shrink OD value tables P₂, [symbol] Q₂, [symbol] R₂ and S₂ 31, 32, 33, 34 by reference the grayscales of the pre-frame and the now-frame to build grayscale functions g₁(y), g₂(y) h₁(x), and h₂(x), calculating the grayscale functions by the calculating unit 42 to develop grayscale functions g(y) and h(x), then the enlarging unit 43 enlarging and getting a OD enlarged value with the function ƒ(x, y)=c×h(x)×g(y);
(4) the comparing unit 50 comparing the grayscales of the pre-frame and the now-frame, if the grayscales being the same or nearly the same, for example error range between the pre-frame and the now-frame is less than 5 grayscales, the comparing unit 50 submitting a signal for OD technique free;
(5) the OD enlarged value, the grayscale of the now-frame, and the signal for OD technique free can being inputting into the multi-functional comparing unit 60, if the multi-functional comparing unit 60 get the signal for OD technique free, it submitting the grayscale of the now-frame, if not, submitting the OD enlarged value;
   thereby, running the steps above, the color display system 1 cannot only faster and more accurate display, but also satisfy different using demands in different places, latitudes, and working environments.

The present invention collects a suitable signal among a grayscale of a now-frame, an OD enlarged value, and a comprised result between grayscales of a pre-frame and a now-frame, so the present invention has the following advantages:

1. Accelerating the grayscale response speed: the OD enlarged values of the present invention is by calculating with shrink OD values, and the shrink OD values are shrink from OD measured values, so the present invention does no need to download and check every real OD value.

2. More accurate display: the way of getting OD enlarged values of the present invention is mentioned above, so the OD enlarged values are nearly the same as real OD measured values. That makes the present invention can more accurate display.

3. Saving hardware source for memory: that is because of that the storage space of the OD enlarged values of the present invention is smaller than OD measured values.

4. Wider working range, with the storage space advantage mentioned above, the present invention can have different OD enlarged value tables for satisfying different using demands in different places, latitudes, and working environments.

In conclusion, according to the description disclosed above, the present invention surely can achieve the expected object thereof to provide a faster and more accurate responding and displaying color display system for various color display devices, it has a high industrial value. Therefore, what we claim as new and desire to be secured by Letters Patent of the United States are:

What is claim is:

1. A color display system having:
a color signal source for proving color signal;
a buffer unit for temporary saving a grayscale of a pre-frame of a color display system;
a storage unit for saving OD (Over Driving) shrink value tables P, Q, R, and S;
an enlarging module for enlarging OD values, including a collecting unit, a calculating unit, and a enlarging unit;
a comparing unit; and
a multi-functional comparing unit; the color display system comprising the steps of:
(1) inputting a grayscale of a pre-frame from the buffer unit to the enlarging module, and inputting grayscale of a now-frame from the color signal source to the comparing unit, the now-frame is after the pre-frame;
(2) the collecting unit collecting some specific shrink OD values from the shrink OD value tables P, Q, R, and S by reference the grayscales of the pre-frame and the now-frame to build grayscale functions g₁(y), g₂(y) h₁(x), and h₂(x), calculating the grayscale functions by the calculating unit to develop grayscale functions g(y) and h(x), then the enlarging unit enlarging and getting a OD enlarged value with the function ƒ(x, y)=c×h(x)×g(y);
(3) the comparing unit comparing the grayscales of the pre-frame and the now-frame, if the grayscales being the same or nearly the same, the comparing unit submitting a signal for OD technique free; and
(4) the OD enlarged value, the grayscale of the now-frame, and the signal for OD technique free can being inputting into the multi-functional comparing unit, if the multi-functional comparing unit get the signal for OD technique free, it submitting the grayscale of the now-frame, if not, submitting the OD enlarged value;
thereby, running the steps above for a color display system faster and more accurate displaying.

2. The color display system as in claim 1, wherein said shrink OD value tables P, Q, R, and S are shrink OD value tables P₁-P_{N}, [symbol] Q₁-Q_{N}, [symbol] R₁-R_{N} and S₁-S_{N}, which depends on temperature, N is the sum number of the tables.

3. The color display system as in claim 1, wherein said enlarging module further has a compensating unit for choosing some specific shrink OD value tables from the shrink OD value tables P, Q, R and S depends on temperature demands and inputting to the collecting unit.

4. The color display system as in claim 1, wherein said function ƒ(x, y)=c×h(x)×g(y) can be polynomial, bilinear, or liner combination of orthogonal functions.

5. The color display system as in claim 1, wherein said color signal is at least one of 8 bits red, green, and blue color signals (R, G, B).

6. The color display system as in claim 1, wherein the OD enlarged value submitted from the multi-functional comparing unit can be output to a panel, driver, or T-con (Timing Controller).

7. The color display system as in claim 1, wherein the system is LCD (liquid crystal display), PDP (Plasma Display Panel), TFT, OLED (Organic Electro Luminesence Display), or PLED (Polymer OLED).
